(19) United States
(12) Patent Application Publication
(10) Pub. No.: US 2010/0143687 A1
(43) Pub. Date: Jun. 10, 2010

(54) POLYPROPYLENE-BASED TAPE YARN PRODUCED FROM EXTRUDED FILM CONTAINING BETA SPHERULITES AND METHODS OF MAKING AND USING THEREOF

(76) Inventor: Philip Jacoby, Marietta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/629,469

(22) Filed: Dec. 2, 2009

Related U.S. Application Data
(60) Provisional application No. 61/119,208, filed on Dec. 2, 2008.

(51) Int. Cl. B32B 5/00; C08L 23/12; C08K 5/3437; C08K 5/42; C08K 5/20; C08K 5/12; C08L 23/14

(52) U.S. Cl. 428/220; 524/582; 524/90; 524/171; 524/226; 524/296; 524/570

(57) ABSTRACT

Disclosed herein is an oriented tape yarn produced from an extruded propylene-based polymer sheet or film comprising beta-spherulites in an amount sufficient to produce a K-value of from about 0.1 to about 0.95. Also disclosed herein are methods for making the tape yarns and their use thereof in carpet backing.

### CROSS REFERENCE TO RELATED APPLICATIONS

This application claims priority upon U.S. provisional application Ser. No. 61/119,208, filed Dec. 2, 2008. This application is hereby incorporated by reference in its entirety for all of its teachings.

### BACKGROUND

Polypropylene tape fibers are used extensively in carpet backings. These tape fibers are made by extruding a polypropylene film which is cooled using either a water bath or metal chill roll. After extrusion the film is oriented and then slit into narrow tapes. The orientation step may be performed either before or after the slitting step. The orientation step can be performed by passing the unoriented film or tape through a heated oven where the drawing takes place. Alternatively the film may be drawn by passing it over a series of heated metal rollers where film passes from a slow roller to a fast roller resulting in a reduction in the thickness of the film and an increase in its tensile strength. The final oriented tape fibers are woven into a carpet backing and the carpet face yarn is tufted into this carpet backing to create the final carpet.

It is generally desirable that the final oriented tape has a dull surface appearance and also be somewhat opaque. The reason for this is that if the tape has a glossy or shiny surface it may be possible to see the carpet backing when the carpet is placed in an illuminated location. Light reflection from the carpet backing can be a particular problem for light weight or short pile carpets where the light can penetrate through the face yarn of the carpet. Often certain mineral fillers such as calcium carbonate or titanium dioxide (TiO₂) are incorporated into the polypropylene resin before it is extruded into a film. These mineral fillers, which are also referred to as delusterants, can provide a dull or matte surface finish to the polypropylene tapes thereby eliminating this objectionable light reflection.

One problem with the use of mineral delusterants is that they are abrasive materials and can cause the slitting knives to become dull. This can cause a shut-down of the production line resulting in a loss of productivity. The mineral fillers can also lead to fiber breakage during the orientation step if the filler particles are agglomerated or not properly dispersed in the polypropylene resin.

Additionally, the tape yarn should enhance the tufting properties of the carpet. The tape yarn should be a strong material with high tensile strength (i.e. high tenacity). However, it is also desirable that the tape yarn be a relatively light material (i.e., reduced density), which ultimately reduces production costs. The tape yarns described herein address these needs.

### SUMMARY

Disclosed herein is an oriented tape yarn produced from an extruded propylene-based polymer sheet or film comprising beta-spherulites in an amount sufficient to produce a K-value of from about 0.1 to about 0.95. Also disclosed herein are methods for making the tape yarns and their use thereof in carpet backing. Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects described below.

FIG. 1 is a photograph showing a tape yarn of the present invention produced with a beta nucleating agent and a tape yarn made without a beta nucleating agent.

FIG. 2 shows the differential scanning calorimeter (DSC) scan of a tape yarn described herein.

### DETAILED DESCRIPTION

The present invention may be understood more readily by reference to the following detailed description of aspects of the invention and the Examples included therein and to the Figures and their previous and following description.

Before the present compounds, compositions, articles, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular embodiments only and is not intended to be limiting.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein may be different from the actual publication dates, which may need to be independently confirmed.

As used in the specification and the appended claims, the singular forms “a,” “an” and “the” include plural referents unless the context clearly dictates otherwise. Thus, for example, reference to “a component,” “a polymer,” or “a particle” includes mixtures of two or more such components, polymers, or particles, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Described herein are polypropylene-based tape yarns produced with beta nucleating agents that are useful as tape yarn fibers in carpet backing. The films generally have a dull or matte finish, which is desirable for carpet backing. The polypropylene-based tape yarn is produced from extruded film that contains a resinous polymer of propylene and an effective amount of beta spherulites. The beta spherulites in the extruded film are produced by the incorporation of a beta nucleating agent in the polymer. Not wishing to be bound by theory, during the film casting process, beta spherulites begin growing from the beta nucleant particles as the melt cools.

Crystalline polypropylene (also known as “isotactic polypropylene”) is capable of crystallizing in three polymorphic forms: the alpha, beta, and gamma forms. In melt-crystallized material the predominant polymorph is the alpha or monoclinic form. The beta or pseudohexagonal form generally occurs at levels of only a few percent, unless certain heterogeneous nuclei are present or the crystallization has occurred in a temperature gradient or in the presence of shearing forces. The gamma or triclinic form is typically only observed in low-molecular weight or stereoblock fractions that have been crystallized at elevated pressures. Each component used to make the tape yarns described herein is discussed in detail below.

As discussed above, beta-nucleating agents are used to produce beta-spherulites during the formation of the tape yarns. The beta-nucleating agent can be any inorganic or organic nucleating agent that can produce beta-spherulites in the melt extruded sheet or film. In one aspect, the beta-nucleating agent can include:

(a) the gamma-crystalline form of a quinacridone colorant Permanent Red E3B, herein referred to as “Q-dye.” The structural formula for Q-dye is:

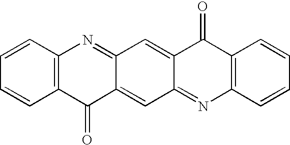

(b) the bisodium salt of o-phthalic acid;
(c) the aluminum salt of 6-quinizarin sulfonic acid;
(d) isophthalic or terephthalic acids; and
(e) N′, N′-dicyclohexyl-2,6-naphthalene dicarboxamide, also known as NJ Star NU-100, developed by the New Japan Chemical Co.

In another aspect, the beta-nucleating agents disclosed in German Patent DE 3,610,644 can be used herein. This beta-nucleating agent is prepared from two components, (A) an organic dibasic acid, such as pimelic acid, azelaic acid, o-phthalic acid, terephthalic acid, and isophthalic acid; and (B) an oxide, hydroxide or an acid salt of a metal of Group II, such as magnesium, calcium, strontium, and barium. The acid salt of the second component (B) may be derived from an organic or inorganic acid, such as a carbonate or stearate. The composition may contain up to 5 wt % of Components A and B (based the weight of the polymer) and preferably contains up to 1 wt % of Components A and B.

In one aspect, the beta-nucleating agent can be 5, 12-dihydro-quino(2,3 b)acridine-7,14-dione with quino(2,3 b)acridine-6,7,13,14 (5H, 12H)-tetrone, N,N′-dicyclohexyl-2,6-naphtalene dicarboxamide and salts of dicarboxylic acids with at least 7 carbon atoms with metals of group Ha of the periodic table. It is also contemplated that any mixture of these compounds can be used as the beta-nucleating agent.

The properties of the resulting tape yarn can vary depending upon the selection and concentration of the beta-nucleating agent. The amount of the beta-nucleating agent depends on the effectiveness of the particular beta-nucleating agent in inducing beta-crystal formation, and the thermal conditions under which the tape yarn is produced. In one aspect, the amount of beta-nucleating agent is sufficient to produce an extruded precursor film corresponding to a K-value obtained by x-ray diffraction analysis of 0.1 to 0.95. In one aspect, the concentration of the beta-nucleating agent is from 0.5 to about 5,000 ppm.

In one aspect, the beta-nucleating agent is Q-dye, which is present in the composition in an amount ranging from 0.1 to about 100 ppm, or from 0.1 to about 50 ppm. The resulting part has a K-value in the range of about 0.1 to 0.95, or from about 0.2 to 0.85. In another aspect, the beta-nucleant is quinacridone colorant Permanent Red E3B and is present in the composition at a level of about 0.5 to about 50 ppm, based on the weight of the resinous polymer of propylene.

The nucleating agents are typically in the form of powdered solids. To efficiently produce beta-crystallites, it is desirable that the powder particles be less than 5 microns in diameter, preferably no greater than 1 micron in diameter.

The beta-spherulite content of the extruded precursor film can be defined qualitatively by optical microscopy, or quantitatively by x-ray diffraction or thermal analysis. In the optical microscopy method, a thin section microtomed from the extruded precursor film is examined in a polarizing microscope using crossed polars. The beta-spherulites show up much brighter than the alpha spherulites due to the higher birefringence of the beta-spherulites.

In the x-ray diffraction method the diffraction pattern of the tape yarn is measured, and the heights of the three strongest alpha phase diffraction peaks, H110, H130 and H040 are determined, and compared to the height of the strong beta phase peak, H300. An empirical parameter known as “K” (herein referred to as the “K-value”) is defined by the equation:

K=(H300)/[(H300)+(H110)+(H040)+(H130)]

The K-value can vary from 0, for a sample with no beta-crystals, to 1.0 for a sample with all beta-crystals.

Thermal analysis of the tape yarn can be characterized by Differential Scanning Calorimetry (DSC) to determine the beta-spherulite nucleation effects. Parameters which are measured during the first and second heat scans of the DSC include the crystallization temperature, T_{c}, the melting temperature, Tₘ, of the alpha (α) and beta (β) crystal forms, and the heat of fusion, ΔH_{f}, including both the total heat of fusion, ΔH_{f-tot}, and the beta melting peak heat of fusion, ΔH_{f-beta}. The melting point of the beta-crystals is generally about 10-15° C. lower than that of the alpha crystals. The magnitude of the ΔH_{f-beta}. parameter provides a measure of how much beta crystallinity is present in the sample at the start of the heat scan. Generally, the second heat of fusion values are reported, and these values represent the properties of the material after having been melted and recrystallized in the DSC at a cool-down rate of 10° C./minute. The first heat thermal scans provide information about the state of the material before the heat history of the processing step used to make the samples had been wiped out. It is desirable that the first heat thermal scan show a distinct melting peak for the beta crystal phase, and the heat of fusion of the beta crystal phase be at least 5% of the total heat of fusion of the alpha and beta crystal phases. Alternatively, the extruded precursor film can have a prominent melting peak for the beta crystal phase on the 1^{st} heat scan when a sample of the film is placed in a DSC and heated at a rate of 10° C. per minute.

Turning to the propylene-based polymer, various types of polyolefin resins can be used as the starting base resin. The propylene-based polymers as referred to herein contain at least one propylene unit. The polymer may be a homopolymer of polypropylene, a random or block copolymer of propylene and another α-olefin or a mixture of α-olefins, or a blend of a polypropylene homopolymer and a different polyolefin. For the copolymers and blends, the α-olefin may be polyethylene or an α-olefin having 4 to 12 carbon atoms. In one aspect, the α-olefin contains containing 4 to 8 carbon atoms, such as butene-1 or hexene-1. In the case of copolymers, it is desirable that at least 50 mol % of the copolymer is formed from propylene monomers. In one aspect, the copolymer may contain up to 40 mol %, and up to 50 mol %, of ethylene or an α-olefin having 4 to 12 carbon atoms, or mixtures thereof. Blends of propylene homopolymers with other polyolefins, such as high density polyethylene, low density polyethylene, or linear low density polyethylene and polybutylene can be used herein.

It is desirable that the propylene-based polymer has a melt flow rate (MFR) great enough for facile and economical production of the extruded tape yarn, but not so great as to produce a tape yarn with undesirable physical properties. In one aspect, the MFR should be in the range of about 0.1 to 50 decigrams/minute (dg/min), or from about 0.5 to 10 dg/min as measured by ASTM-1238. When the MFR of the resin exceeds 100 dg/min, disadvantages are caused by the brittleness or reduced tensile strength of the tape yarn. When the MFR is less than 0.1 dg/min, difficulties are encountered in extruding the film due to the high melt viscosity. It is also possible to blend polypropylene-based polymers of different melt flow rates to obtain a final average MFR which is in the desired range.

In one aspect, the propylene-based polymer is a polypropylene homopolymer or blend thereof. In a further aspect, the propylene-based polymer comprises polypropylene. In a further aspect, the propylene-based polymer comprises a random or block copolymer selected from the group consisting of copolymers of propylene and ethylene, copolymers of propylene an α-olefin with 4 to 12 carbon atoms, copolymers of polypropylene and a mixture of α-olefins with 4 to 12 carbon atoms, and copolymers of propylene and ethylene and one or more α-olefins with 4 to 12 carbon atoms.

The propylene-based polymer can be admixed as needed with a variety of additives, including lubricants, antioxidants, ultraviolet absorbers, radiation resistance agents, antistatic agents, coupling agents, coloring agents, such as pigments and dyes, opacifiers, such as TiO₂ and carbon black. Standard quantities of the additives are included in the resin, although the addition of any minerals or abrasive additives should be kept to a minimum. Care should be taken to avoid incorporation of other nucleating agents or pigments that act as nucleating agents since these materials may prevent the proper nucleation of beta-spherulites. For example, alpha nucleating agents that should omitted from the formulation include sodium benzoate, lithium benzoate, NA-11 from Amfine, which is the sodium salt of 2,2′-methylene bis(4,6-di-tert-butylphenyl) phosphate, and sorbitol clarifiers, such as Millad 3988 from Milliken Chemicals (i.e., bis(3,4-dimethylbenzylidene) sorbitol). Radical scavengers, such as dihydroxy talcite, should also be avoided since they have some nucleating ability.

Preferred antistatic agents include alkali metal alkane sulfonates, polyether-modified (i.e., ethoxylated and/or propoxylated) polydiorganosiloxanes, and substantially linear and saturated aliphatic tertiary amines containing a C₁₀₋₂₀ aliphatic radical and substituted by two C₁₋₄ hydroxyalkyl groups, such as N,N-bis-(2-hydroxyethyl)-alkyl amines containing C₁₋₂₀, preferably C₁₂₋₁₈, alkyl groups.

A number of techniques can be used to make the tape yarns described herein. In one aspect, the tape yarn can be made by the following steps: (1) melt compounding a propylene-based polymer containing an effective amount of beta-nucleating agent capable of producing beta spherulites in the extruded sheet or film, together with optional stabilizing additives, in order to produce pellets of a beta-nucleated resin; and (2) feeding the pellets into a film extruder in order to produce the extruded tape yarn.

In another aspect, the tape yarn can be produced by mixing pellets of a masterbatch containing the beta-nucleating agent with pellets of a propylene-based polymer that does not contain any alpha-nucleating agents. This pellet mixture can then be fed into the sheet extruder in the manner described in the previous paragraph in order to produce a final tape yarn.

In general, the beta-nucleating agent can be dispersed in the propylene-based polymer by any suitable procedure normally used in the polymer art to effect thorough mixing of a powder with a polymer resin. For example, the beta-nucleating agent can be powder blended with the propylene-based polymer in powder or pellet form or the beta-nucleating agent can be slurried in an inert medium and used to impregnate or coat the propylene-based polymer resin in powder or pellet form. Alternatively, powder and pellets can be mixed at elevated temperatures by using, for example, a roll mill or multiple passes through an extruder. A preferred procedure for mixing is the blending of the beta-nucleating agent powder and base propylene-based polymer resin pellets or powder and melt compounding this blend in an extruder. Multiple passes through the extruder may be necessary to achieve the desired level of dispersion of the beta-nucleating agent. Ordinarily, this type of procedure can be used to form a masterbatch of pelletized resin containing sufficient beta-nucleating agent so that when a masterbatch is let down in ratios of 10/1 to 200/1 (polymer to beta-nucleating agent) and blended with the base resin, the desired level of beta-nucleating agent is obtained in the final product.

In one aspect, a concentrate composed of the beta-nucleating agent and a propylene-based polymer can be used to fabricate the tape yarn. In one aspect, the concentrate is a highly loaded, pelletized propylene-based polymer resin containing a higher concentration of nucleating agent than is desired in the final product. The nucleating agent can be present, for example, in the concentrate in a range of from about 0.005% to about 2.0% (about 50 ppm to about 20,000 ppm), more preferably in a range of from about 0.0075% to about 1% (about 75 ppm to about 10,000 ppm). Typical concentrates can be blended with a non-nucleated propylene-based polymer in the range of from about 0.1% to about 10% of the total polypropylene content of the extruded sheet or film, for example, from about 0.5% to about 5.0% of the total polypropylene content of the extruded film or sheet. The final product can thus contain from about 0.00005% to about 0.1% (about 0.5 ppm to about 1000 ppm), for example, from about 1 ppm to about 200 ppm. A concentrate can also contain other additives such as stabilizers, pigments, and processing agents, but does not usually contain any additives which significantly nucleate the alpha crystal form of polypropylene.

In one aspect, the polymer concentrate can include a propylene-based polymer, and at least one beta-nucleating agent in a concentration of from about 0.01% to about 2.0% based upon the weight of the concentrate. In a yet further aspect, the beta-nucleating agent is present in a concentration of from about 0.1 to 200 ppm and has the structural formula:

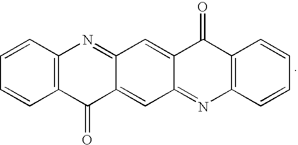

In another aspect, a concentrate of Q-dye masterbatch can be formed by first adding a sufficient amount of the quinacridone dye to the polypropylene resin to form a polypropylene resin containing 40% of the quinacridone dye. 3% of this concentrate is then extrusion compounded with an additional 97% of polypropylene to make a new concentrate that contains 1.2% of the quinacridone dye (“the 1.2% concentrate”). A third compounding step is then performed where 3% of the 1.2% concentrate is blended with 97% of polypropylene and to make a new concentrate that contained 0.036% of the quinacridone dye. This final concentrate is then added at a 2% level to the base polypropylene used to make the extruded film or sheet containing 0.00072% or 7.2 ppm of the quinacridone dye.

After the beta-nucleating agent and propylene-based polymer have been melt-blended, the blend is extruded to produce the tape yarn. In one aspect, the extrusion step can be a melt extrusion slit-die or T-die process. Extruders used in such a melt-extrusion process can be single-screw or twin-screw extruders. Preferably, such machines are free of excessively large shearing stress and are capable of kneading and extruding at relatively low resin temperatures.

For producing a coextruded multi-layer film with one layer that contains a beta-nucleated resinous polymer, one extruder may be used to extrude a part of the beta-spherulite nucleated resin. A second extruder may be used to extrude a layer of non-nucleated polymer resin, which is located on at least one side of the nucleated resin. If a layer of non-nucleated resin is desired on both sides of the beta-nucleated resin, then a non-nucleated polymer melt can be split between two slit-dies and a second layer of injection molded non-nucleated polymer part will be in contact with the other side of the beta-nucleated polymer resin layer between a second set of nip rolls. One of both of these layers can contain a natural fiber filler. Alternatively, more than one extruder can be used to supply molten polymer to a coextrusion die. This allows two or more distinct polymer layers to be coextruded from a given slit-die.

The temperature at the die exit should be controlled, such as through the use of a die-lip heater, to be the same as or slightly higher than the resin melt temperature. By controlling the temperature in this manner, “freeze-off” of the polymer at the die lip is prevented. The die should be free of mars and scratches on the surface so that it produces a film with smooth surfaces. The thickness of the extruded film can be in the range of 1 to 20 mils, 2 to 18 mils, 3 to 16 mils, or 4 to 14 mils where 1 mil is one-one thousandth (0.001) of an inch.

In a further aspect, the method for making the tape yarn further includes the step of casting the extruded propylene-based polymer sheet or film onto a heated chill roll. In this aspect, the roll temperature can be adjusted to produce a sheet containing high levels of beta crystallinity (e.g., a K-value obtained by x-ray diffraction analysis of 0.1 to 0.95). For example, the cast roll temperature can be in excess of 75° C. (170° F.).

In a further aspect, the method for making the tape yarn further includes the step of casting the extruded polypropylene-based sheet or film into a heated water bath. In this respect, the water bath temperature can be adjusted to produce a sheet containing high levels of beta crystallinity (e.g., a K-value obtained by x-ray diffraction analysis of 0.1 to 0.95). For example, the water bath temperature can be in excess of 75° C. (170° F.).

In a further aspect, the method further comprises the step of orienting the extruded sheet in the machine direction (MD) by heating this sheet to a temperature in the range of 50° C. to 130° C. by passing the sheet over a series of heated rollers, where the orientation takes place as the sheet passes from a slow roller to a fast roller. The draw ratio of the oriented film is the ratio of the speed of the fast roller to the speed of the slow roller, if the two rollers have the same diameter. This orientation step can also be performed by drawing the film through an air oven, with the air temperature set so as to heat the film to a temperature in the range of 50° C. to 130° C. when the drawing takes place. The draw ratio can be in the range of 3:1 to 8:1, or 4:1 to 7:1. The final oriented tape can have a thickness in the range of 0.1 to 10, 0.2 to 8 mils, or 0.5 to 7 mils. The orientation step is done under conditions where the final oriented film has a dull or matte surface texture and ranges in appearance from translucent to opaque. Generally lower draw temperatures produce films with greater opacities. Lower draw temperatures also produce oriented tape yarns with higher levels of microvoiding and a lower density. The importance of microvoiding with respect to the tape yarns is addressed below. Not wishing to be bound by theory, after this precursor extruded film is stretched, the beta crystals present in the film transform into alpha crystals, where the final tape yarn contains only an alpha crystal phase.

The tape yarns described herein can be woven into a carpet backing and the carpet face yarn is tufted into this carpet backing to create the final carpet, in the same manner as standard tape yarns made without the use of beta nucleation. In general, the tape yarn has a dull or matte finish surface appearance and is also more opaque than tape yarn made without the use of beta-nucleating agents (see Examples). As discussed above, it is desirable that a carpet tape yarn have a dull surface appearance and also be somewhat opaque. The reason for this is that if the tape has a glossy or shiny surface it may be possible to see the carpet backing when the carpet is placed in an illuminated location. Light reflection from the carpet backing can be a particular problem for light weight or short pile carpets where the light can penetrate through the face yarn of the carpet. Often certain mineral fillers such as calcium carbonate or titanium dioxide (TiO₂) are often incorporated into the polypropylene resin before it is extruded into a film. These mineral fillers, which are also referred to as delusterants, can provide a dull or matte surface finish to the polypropylene tapes thereby eliminating this objectionable light reflection.

One problem with the use of mineral delusterants is the fact that they are abrasive materials and can cause the slitting knives to become dull. This can cause a shut-down of the production line resulting in a loss of productivity. The mineral fillers can also lead to fiber breakage during the orientation step if the filler particles are agglomerated or not properly dispersed in the polypropylene resin. The tape yarns described herein do not require delusterants and, thus, do not possess these draw-backs.

In addition to being opaque, the tape yarns possess high levels of microvoids. Not wishing to be bound by theory, the beta-nucleating agents used herein can induce microvoid formation in the tape yarn during the stretching of the precursor extruded film to produce the final tape yarn. Increased microvoid formation results in tape yarns that have a lower density. This decrease in density results in more square yards of tape yarn produced per pound of polypropylene resin, and therefore lowers raw material costs. For example, the tape yarns described herein can have density reductions of up to 5% and 10% when processed under the right conditions. Thus, less raw material is needed to produce tape yarns made from beta nucleated polypropylene with the same size (area), strength and stiffness as tape yarns formed of polypropylene made without the use of beta nucleation. In one aspect, the achievable weight reduction is at least 5%, or at least 10%, based on the weight of the non-nucleated tape yarns.

In addition to reduced density, the tape yarns described herein are also stronger compared to tape yarns that do not contain beta-spherulites. The tape yarns described herein when incorporated into a carpet backing can increase the stiffness and strength of the backing without significantly adding to the weight of the backing. Additionally, the presence of the microvoids can result in improved tufting properties of the backing such as small penetration resistance to tufting needles and a more uniform distribution of penetration resistance. In one aspect, the tape yarns described herein have a tensile strength that is greater than 5%, greater than 10%, or greater than 15% compared to the same tape yarn made from polypropylene sheet that does not contain beta-spherulites. In another aspect, the tape yarns described herein have a tensile strength that is from than 5% to 20% greater than the same tape yarn made from polypropylene that does not contain beta-spherulites. This is an unexpected result considering the presence of the microvoids in tape yarn would in general reduce the tensile strength of the tape yarn.

The tape yarns described herein can be cut into narrow tapes that can have widths and thicknesses that are in the range of that typically used to produce woven carpet backing fabrics. The tapes described herein can be used for either the “warp” or the “weft” yarn or for both yarns of the carpet backing fabrics. The terms “warp” and “weft” are used in their commonly accepted meanings in the carpet industry.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### (Prophetic)-Production of an Oriented Polypropylene Tape Yarn

The following prophetic example describes the production of an oriented polypropylene tape yarn made from a beta nucleated polypropylene resin without the use of any fillers, pigments, or delustering agents.

The beta-nucleating agent can be a red quinacridone dye, known as Hostaperm Red E3B, herein referred to as “Q-dye” (CAS No.: 16043-40-6). This dye can be incorporated into a polypropylene homopolymer resin (Sunoco F120F, produced by Sunoco Corporation) using extrusion compounding. The resin can have a melt flow rate of 12.0 g/10 min. The concentration of the Q-dye can be 0.01% (100 ppm). A non-nucleating green pigment such as Milliken Cleartint Green 9807 at a concentration of 1.0% can also be incorporated into this polypropylene concentrate. The final pellets of this polypropylene concentrate can have a grey color. About 2% of these grey pellets can be then compounded with 98% of a natural polypropylene resin at the hopper of the film casting extruder. This natural polypropylene resin can have a melt flow rate in the range of 2-10 g/10 minutes.

The molten polymer blend can be extruded using a flat film die onto a heated metal cast roll. The extruded film thickness can be 6 mils (0.006″). The cast roll surface temperature can be in the range of 80° C. to 120° C., and preferably from 90° C. to 110° C.

Sample 1 can be made using 100% of a non-nucleated polypropylene resin, with a melt flow rate of about 3 g/10 min. In one aspect, a beta-nucleating masterbatch or concentrate is not included in Sample 1. Sample 1 can be extruded into a film having a thickness of approximately 6 mils using a cast roll that can be heated to 100° C. Following extrusion the film can be oriented in the machine direction using a draw ratio of 4:1 by passing the film from a slow roller to a fast roller. The temperature of the film during the stretching process is 90° C.

Sample 2 can be made under the same processing conditions as Sample 1, except 2.0% of the Q-dye concentrate containing 100 ppm of the Q-dye can be introduced into the feed, together with 98% of the non-nucleated polypropylene resin, resulting in an extruded film that contains 2.0 ppm of the Q-dye. Sample 2 can be extruded into a film having a thickness of approximately 6 mils using a cast roll that can be heated to 100° C. Following extrusion the film can be oriented in the machine direction using a draw ratio of 4:1 by passing the film from a slow roller to a fast roller. The temperature of the film during the stretching process is 90° C.

Predicted data for the 2 samples are listed in Table 1.

TABLE 1
Part Composition Properties

| Property | Sample 1 | Sample 2 |
|---|---|---|
| Extruded film thickness (mils) | 6 | 6 |
| Q-dye (ppm) | 0 | 2.0 |
| Oriented film thickness (mils) | 1.5 | 1.6 |
| Oriented film density (g/cm3) | 0.905 | 0.835 |
| Oriented Film Opacity | 10% | 50% |
| Oriented film Surface | Shiny | Matte |
| appearance | | |
| DSC Data - 2^{nd} Heat Scan | | |
| Tₘ-∞ (° C.) | 169.0 | 168 |
| Tₘ-β (° C.) | — | 154 |
| ΔH_{f-tot} (cal/g) | 21.0 | 21.0 |
| ΔH_{f-beta} (cal/g) | — | 15.0 |
| DSC Cool Down Scan | | |
| T_{c} (° C.) | 112.0 | 121.0 |
| X-ray “K” Value on | 0 | 0.75 |
| Extruded Film | | |

The predicted data in Table 1 indicate that Sample 1 film contains no evidence of beta crystals, and only a single melting peak for the alpha crystal phase is seen in both the first and second heat scans. The low T_{c} value of 112.0° C. can also be indicative of a non-nucleated material.

The precursor extruded film used to make Sample 2 can show a distinct beta melting peak is seen in both the first and second heat scan indicating that a high level of beta crystals is present. The high K-values for these extruded film samples also show that they contain a very high level of beta crystallinity. The magnitude of the ΔH_{f-beta} parameter is a measure of how much beta crystallinity is present in the sample at the start of the heat scan. Generally, the second heat ΔH values are reported, and these are representative of the properties of the material after having been melted in the DSC at a cool-down rate of 10° C. per minute. The first heat thermal scans provide information about the state of the material after it crystallized during the extrusion of the part. The very large values for the ΔH_{f-beta} parameters can demonstrate that the Q-dye can be very effective as a beta nucleant in Samples 2. The elevated T_{c} values for the films of Samples 2 also indicate that it can be effectively nucleated by the Q-dye.

Preparation of Polypropylene Carpet Tape Yarn

This example relates to an actual trial which took place on a polypropylene tape yarn line, which produced an oriented polypropylene tape yarn made from a beta nucleated polypropylene resin without the use of any fillers, pigments, or delustering agents.

The beta nucleant used was incorporated into a masterbatch in a polypropylene carrier resin. This masterbatch is commercially available from Mayzo Corporation and is identified as MPM 1113. The masterbatch contains a quinacridone-type beta nucleating agent. This masterbatch was added to a non-nucleated 3.2 MFR polypropylene homopolymer resin at a 1% addition level at the extruder hopper.

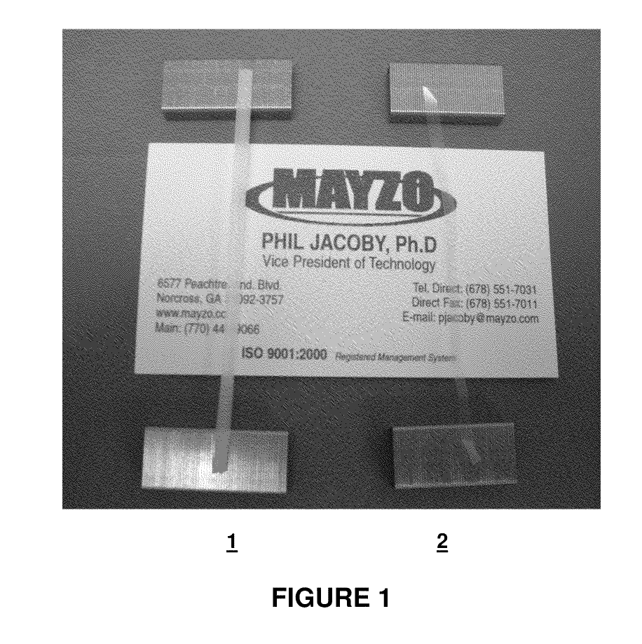

An extruded polypropylene film having a thickness of about 0.0054″ was produced by casting the film onto a heated chill roll with a surface temperature of about 93° C. After cooling the film was slit into 0.25″ wide strips and then stretched by drawing the strips in an air heated oven using a draw ratio of about 6:1. The film containing the beta nucleant masterbatch had a milky white appearance with a dull surface finish (tape 1 in FIG. 1), while the film made with no beta nucleant additive had a clear and shiny surface appearance (tape 2 in FIG. 1).

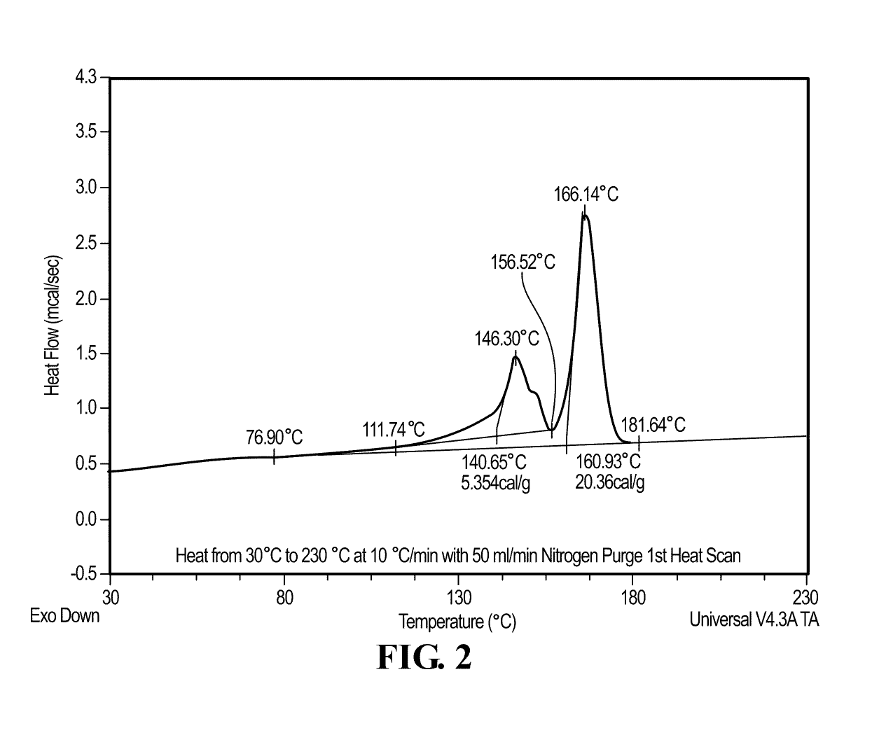

The cast beta nucleated film used to make the final oriented tape also exhibited a significant beta crystal content as evidenced by the 1^{st} heat DSC scan obtained on this film, which is shown in FIG. 2.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. An oriented polypropylene tape yarn comprising a propylene-based polymer formed from an extruded film or tape comprising beta-spherulites in an amount sufficient to produce a K-value of from about 0.1 to about 0.95.

2. The tape yarn of claim 1, wherein the beta-spherulites are produced by a beta-nucleating agent.

3. The tape yarn of claim 2, wherein the beta-nucleating agent is present in a concentration of from about 0.1 to about 5,000 ppm.

4. The tape yarn of claim 2, wherein the beta-nucleating agent is present in a concentration of from about 0.1 to 500 ppm and has the structural formula:

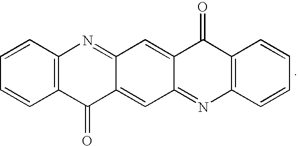

5. The tape yarn of claim 2, wherein the beta-nucleating agent is the bisodium salt of o-phthalic acid, the aluminum salt of 6-quinizarin sulfonic acid, N′, N′-dicyclohexyl-2,6-naphthalene dicarboxamide, or any combination thereof.

6. The tape yarn of claim 2, wherein the beta-nucleating agent is prepared from (A) an organic dibasic acid; and (B) an oxide, hydroxide or an acid salt of a metal of Group II.

7. The tape yarn of claim 2, wherein the beta-nucleating agent is 5, 12-dihydro-quino(2,3 b)acridine-7,14-dione with quino(2,3 b)acridine-6,7,13,14 (5H, 12H)-tetrone, N,N′-dicyclohexyl-2,6-naphtalene dicarboxamide or salts of dicarboxylic acids with at least 7 carbon atoms with metals of group Ha of the periodic table.

8. The tape yarn of claim 1, wherein the propylene-based polymer is a polypropylene homopolymer or blend thereof.

9. The tape yarn of claim 1, wherein the propylene-based polymer comprises polypropylene.

10. The tape yarn of claim 1, wherein the propylene-based polymer comprises a random or block copolymer selected from the group consisting of a copolymer of propylene and ethylene, a copolymer of propylene and an α-olefin with 4 to 12 carbon atoms, a copolymer of polypropylene and a mixture of two or more α-olefins with 4 to 12 carbon atoms, and a copolymer of propylene, ethylene and one or more α-olefins with 4 to 12 carbon atoms.

11. The tape yarn of claim 1, wherein the tape yarn has a thickness less than 10 mils.

12. The tape yarn of claim 1, wherein the tape yarn has a tensile strength that is at least 5% greater than the same tape yarn that does not contain beta-spherulites.

13. The tape yarn of claim 1, wherein the tape yarn has a density that is at least 5% less than the same tape yarn that does not contain beta-spherulites.

14. A method for making an oriented polypropylene-based tape yarn comprising the steps of:
a. melt forming a propylene-based extruded sheet or film comprising at least one beta-nucleating agent;
b. cooling the propylene-based extruded sheet or film at a temperature sufficient to produce beta-spherulites in an amount sufficient to produce a K-value of from about 0.1 to about 0.95, and
c. orienting the propylene-based extruded sheet or film to produce a tape yarn having a thickness that is less than 10 mils.

15. The method of claim 14, wherein prior to step (a), combining a polymer concentrate with a non-nucleated propylene-based polymer resin, wherein the polymer concentrate comprises
a. a propylene-based polymer; and
b. at least one beta-nucleating agent in a concentration of from about 0.01% to about 5.0%, based upon the weight of the concentrate.

16. The method of claim 15, wherein the beta-nucleating agent is present in a concentration of from about 50 ppm to 5,000 ppm and has the structural formula:

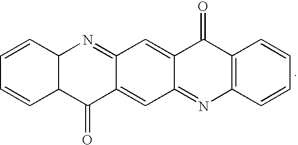

17. The method of claim 15, wherein the beta-nucleating agent is the bisodium salt of o-phthalic acid, the aluminum salt of 6-quinizarin sulfonic acid, N′, N′-dicyclohexyl-2,6-naphthalene dicarboxamide, or any combination thereof.

18. The method of claim 15, wherein the beta-nucleating agent is prepared from (A) an organic dibasic acid; and (B) an oxide, hydroxide or an acid salt of a metal of Group II.

19. The method of claim 15, wherein the beta-nucleating agent is 5, 12-dihydro-quino(2,3 b)acridine-7,14-dione with quino(2,3 b)acridine-6,7,13,14 (5H, 12H)-tetrone, N,N′-dicyclohexyl-2,6-naphtalene dicarboxamide or salts of dicarboxylic acids with at least 7 carbon atoms with metals of group Ha of the periodic table.

20. The method of claim 15 wherein the propylene polymer is a polypropylene homopolymer or blend thereof.

21. The method of claim 15 wherein the propylene-based polymer comprises polypropylene.

22. The method of claim 15 wherein the propylene-based polymer comprises a random or block copolymer selected from the group consisting of a copolymer of propylene and ethylene, a copolymer of propylene and an α-olefin with 4 to 12 carbon atoms, a copolymer of polypropylene and a mixture of α-olefins with 4 to 12 carbon atoms, and a copolymer of propylene, ethylene and one or more α-olefins with 4 to 12 carbon atoms.

23. A tape yarn produced by the method of claim 14

24. A carpet backing comprising an oriented polypropylene tape yarn of claim 1.

25. A carpet backing comprising an oriented polypropylene tape yarn of claim 23
